(19) United States
(12) Patent Application Publication
(10) Pub. No.: US 2015/0180926 A1
(43) Pub. Date: Jun. 25, 2015

(54) SYSTEM AND METHOD FOR STREAMING FTP DATA TO CLIENT APPLICATIONS

(71) Applicant: Bloomberg Finance L.P., New York, NY (US)

(72) Inventors: Koray ONCEL, Manhasset, NY (US); Haim Cohen, Forest Hills, NY (US); Albert Dang, Brooklyn, NY (US)

(73) Assignee: Bloomberg Finance L.P., New York, NY (US)

(21) Appl. No.: 14/576,839

(22) Filed: Dec. 19, 2014

Related U.S. Application Data
(60) Provisional application No. 61/918,252, filed on Dec. 19, 2013.

(51) Int. Cl. H04L 29/06; H04L 29/08

(52) U.S. Cl. CPC H04L 65/60; H04L 67/06; H04L 67/42

(57) ABSTRACT

The present disclosure describes a system and method for streaming data contained in a file being transferred via FTP to one or more client applications. A streaming software module may call a subscription API when a file is being transferred via FTP. The streaming module may call the subscription API to stream data contained in the file to one or more client applications while the file is being downloaded. One or more client applications may use a client API to receive the data stream.

### BACKGROUND

Users of networked computer systems desire to transfer data reliably and efficiently to and from other networked computer systems. File transfer protocol (hereinafter “FTP”) is a service that runs on Transmission Control Protocol/Internet Protocol (hereinafter “TCP/IP”) networked computer systems and provides for the ability to send and receive data to and from a plurality of TCP/IP networked computer systems. FTP has been used as a reliable method for transferring data for decades, in part because FTP moves large amounts of data efficiently and performs error checking to ensure accuracy. FTP enables a user of a computer system to log on to a remote computer system while maintaining local file and directory control. Furthermore, FTP allows users to transfer data to and from their computer systems in a plurality of data formats, for example binary data and ASCII text data.

A FTP session typically begins with a user identifying a uniform resource locator (hereinafter “URL”) or, alternatively, an Internet Protocol (hereinafter “IP”) address of a remote computer system. Computer systems that provide FTP services are referred to herein as “FTP servers.” FTP servers are configured to provide private and/or public access to their data. The abundance of users on global computer networks such as the Internet has encouraged the development of FTP “front-end” applications to provide user-friendly interfaces for data transfers to and from FTP servers. Such FTP front-end applications are installed on an end-user's computer system, and are referred to herein as “FTP client programs.” FTP client programs communicate with FTP servers and implement essential elements of file transfer protocol without significant user intervention. For example, the need to “manually” type commands on a command line in order to affect data transfer between the FTP client program and a FTP server is eliminated. A plurality of FTP functions, for example downloading data, uploading data, listing files in directories and the like are performed via screen menus and other graphical user interface controls which dramatically simplify the FTP process for end-users.

Despite these FTP programs providing transfer of a file from an FTP server between clients, problems remain. For example, a user must still fully upload a file to the FTP server before the downloading user may begin downloading the file. The time between full upload and download is especially large for large files and/or low bandwidth connectivity during uploading. What is needed, therefore, are quicker methods, systems, and media that remove reliance on a user's full upload of a file to an FTP server before another user or application may download the same file.

### SUMMARY

Embodiments of the present disclosure facilitate streaming data contained in a file being transferred via FTP to one or more client applications while the file is being downloaded. In accordance with an embodiment of the present disclosure, a log file may be scanned to determine whether a file is being transmitted to a FTP server from a remote computer. In one embodiment, the log file may be maintained or updated by the FTP server. If it is determined that a file is being transferred, the FTP server may begin downloading the file. While the file is being downloaded, a streaming module may call a subscription API to stream the data from the FTP server to one or more applications before the entirety of the file is received. The one or more applications may use a client API to receive the data stream.

In accordance with an embodiment, the one or more applications may include a parsing application which may be configured to parse text data contained in the file to automatically generate news headlines.

The embodiments described herein may furthermore be carried out on a computing device that performs operations based on execution of code stored on a non-transitory computer readable medium. In accordance with an embodiment of the present disclosure, a non-transitory computer readable medium has executable code stored thereon, that when executed, causes a computing device to perform at least the following steps: scanning a log file to determine whether a file is being transmitted to a FTP server from a remote computer; incrementally receiving data contained in the file if it is determined that the file is being transmitted, wherein the data will be received until the entirety of the file is received; and streaming the data, as the data is being received, from the FTP server to the one or more applications before the entirety of the file is received.

The embodiments described herein may furthermore be carried out on a system comprising at least a server computer comprising a processor. The processor may be configured for scanning a log file to determine whether a file is being transmitted to a FTP server from a remote computer; incrementally receiving data contained in the file if it is determined that the file is being transmitted, wherein the data will be received until the entirety of the file is received; and streaming the data, as the data is being received, from the FTP server to the one or more applications before the entirety of the file is received.

The aforementioned embodiments and other advantages of the embodiments described herein will be apparent to those of ordinary skill in the art at least by reference to this summary, the following detailed description, and the accompanying drawings.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 illustrates an exemplary block diagram of an environment in accordance with the embodiments of the present disclosure;

FIG. 2 illustrates an exemplary flow diagram showing an algorithm in accordance with the embodiments of the present disclosure; and

FIG. 3 illustrates a high-level diagram of a computing device that may be used to implement various aspects of the present disclosure.

### DETAILED DESCRIPTION

Detailed embodiments of the present disclosure are provided herein. Any and all disclosed embodiments are merely exemplary and may be embodied in various and alternative forms, and combinations thereof. As used herein, “exemplary,” and similar terms, may refer expansively to embodiments that serve as an illustration, specimen, model, or pattern. The figures may include exaggerated or minimized features, in order to adequately show details of particular components. In certain instances, well-known components, systems, materials or methods that have not been described in detail in order to avoid obscuring from the focus of the present disclosure. Therefore, specific structural and functional details disclosed herein are in no way to be interpreted as limiting, but merely as a basis for the claims and as a representative basis recognizable to one skilled in the art to employ the present disclosure.

While the detailed description may include a general context of computer-executable instructions, the present disclosure may be implemented in combination with other program modules and/or as a combination of hardware and software. Thus, terms such as “computer” or “computing device” as used herein are expansive and are meant to include routines, program modules, programs, components, data structures, algorithms, and the like. Various systems may also be used for the implementation of the embodiments described herein, including single processor or multi-processor systems, minicomputers, mainframe computers, personal computers, hand-held computing devices, microprocessor-based computers, programmable consumer electronics, in-vehicle computing devices, and any of the aforementioned combinations thereof, and the like.

The present disclosure describes a system and method for streaming data contained in a file being transferred via FTP to one or more client applications. The embodiments disclosed herein may be implemented in a news or media environment where it may be advantageous to process information as quickly as possible. For example, time sensitive news or information transmitted by contributors (journalists, reporters, etc.) of a news organization may need to be processed and transmitted to subscribers as fast as possible. In particular, it would be advantageous for a news organization to be the first outlet to report market moving financial news and information.

Typically, contributors submit information using the file transfer protocol (FTP). The news organization and the contributors may use any one of the various readily available FTP clients to download and upload files. For example, reporters in the field may upload files to the news organization's FTP server using one of various FTP client applications such as PureFTP, SmartFTP, etc. As will be apparent to one of ordinary skill in the art, FTP is a standard network protocol used to transfer files from one host to another host over a TCP-based network, such as the Internet. FTP is built on a client-server architecture and uses separate control and data connections between the client and the server.

Prior art FTP systems require that a file be completely downloaded before the contents of the file can be processed. In a time sensitive environment as discussed above, it would be advantageous to process the contents of the file while the file is being downloaded.

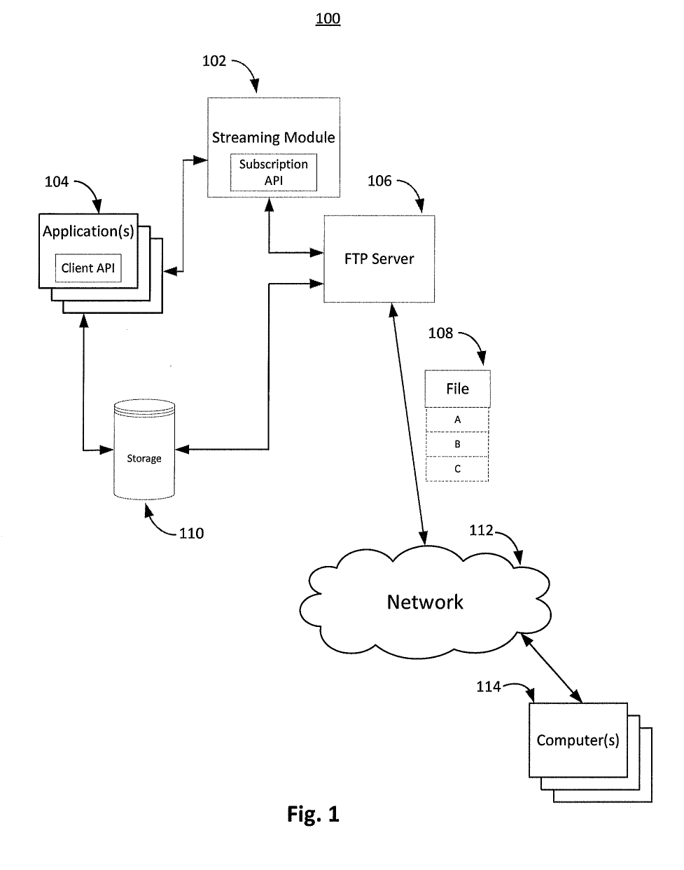

FIG. 1 illustrates a block diagram of an exemplary environment in which embodiments of the present disclosure may be practiced. Not all the components may be required to practice various embodiments, and variations in the arrangement and type of the components may be made. As shown, environment 100 includes FTP server 106, streaming module 102, one or more applications 104, storage device 110, network 112, and one or more computers 114. Computer(s) 114 may vary widely in configuration or capabilities, but generally may include, a CPU (not shown) coupled to memory (not shown). One or more computers 104 may also include one or more wired or wireless network interfaces (not shown), one or more input/output interfaces (not shown), or one or more operating systems (not shown), such as Windows, Mac OS X, Unix, Linux, FreeBSD, or the like. Devices capable of operating as a computer may include, as examples, desktop computers, laptop computers, mobile devices such as smartphones, tablets, etc., as well as integrated devices combining various features, such as two or more features of the foregoing devices, or the like. Computer(s) 114 may have installed thereon FTP client software. In one embodiment, a contributor to a news organization may transmit file 108 containing time-sensitive content to the organization, via network 112, by uploading file 108 using the FTP client software. As shown, file 108 may comprise components A, B, and C.

Network 112 is configured to couple network devices with other computing devices. Network 112 is enabled to employ any form of computer readable media for communicating information from one electronic device to another. Also, network 112 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 112. Furthermore, remote computers and other related electronic devices could be remotely connected to either LANs or WANs via a modem and temporary telephone link. In essence, network 112 includes any communication method by which information may travel between computing devices.

In one embodiment, FTP server 106 may be implemented as a software application. In one embodiment, FTP server 106 is implemented as a html application running on a physical server computer (not shown). FTP server 106 may maintain and/or update a log file (not shown), which may be updated as files are being transferred. In one embodiment, the log file may include a log of when files are being uploaded/downloaded to/from the FTP server. Streaming module 102, which may be implemented as a software application, may monitor the log file by periodically scanning the log file to determine when a file is being transferred. If it is determined that a file is being transferred, streaming module 102 may call the subscription API to stream the contents of the file. Streaming module 102 may stream the contents of the file to one or more applications 104 while the file is being received. In one embodiment, one or more applications 104 may receive the streaming content using the client API. As will be apparent to one of skill in the art, an API (application programming interface) is a set of routines, protocols, and tools which specify how software components should interact. In the present disclosure, the client API enables applications 104 to receive a data stream being provided by subscription module 102 using the subscription API.

In one embodiment, one or more applications 104 may include for example a parser which may parse text included in the file to automatically generate news headlines. Storage 110, which may include non-volatile memory may be used to store file 108. It should be noted that although the FTP protocol is illustrated, embodiments of the disclosure may be implemented using any other protocol such as HTTP, HTTPS, SFTP, etc. It should be noted that in prior art systems, the entirety of file 108, which includes portions A, B and C, would have to be received by a FTP server before the contents of the file may be processed.

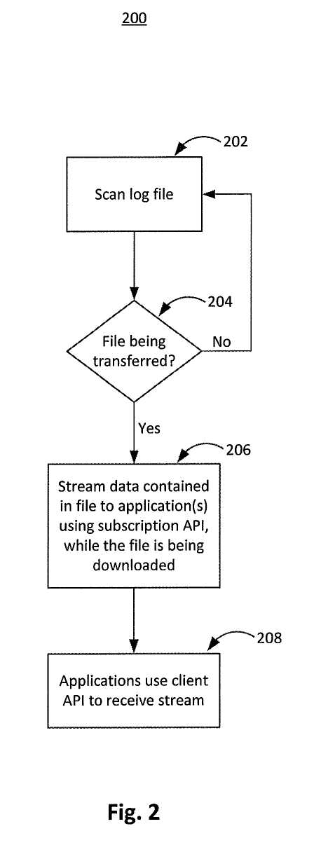

FIG. 2 illustrates an exemplary flow diagram showing an algorithm in accordance with the embodiments described herein. Method 200, as shown, illustrates an algorithm for streaming data contained in a file being transferred via FTP to one or more client applications. At step 202, a log file may be scanned to determine if a file is being transferred via FTP. In one embodiment, the log file may be maintained by a FTP server application. In one embodiment, the log file may be scanned periodically, e.g., every minute. If it is determined in step 204 that a file is being transferred, the file may be downloaded incrementally in step 206. In addition, as the file is being downloaded, the data being downloaded may be streamed to one or more client applications using a subscription API in step 206. In step 208, the applications may use a client API to receive the data stream. As discussed above, the applications may include for example, a parsing application which may parse text data included in the data stream to automatically generate news headlines.

It shall be understood that each block of a flowchart illustration need not be limited in the ordering shown in the illustration, and might be performed in any ordering, or even performed concurrently, without departing from the spirit of the embodiments described herein. It will also be understood that each block of the flowchart illustration, and combinations of blocks in the flowchart illustration, can be implemented by execution of computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

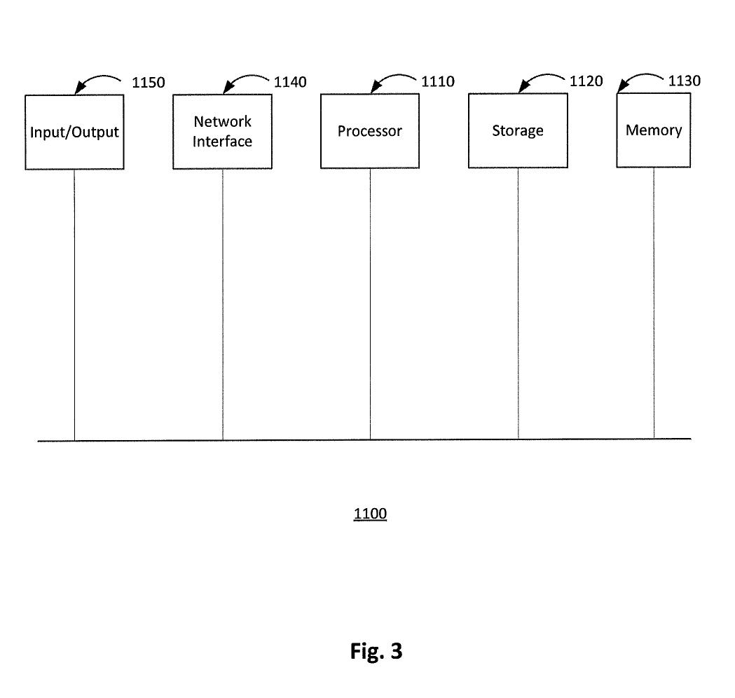

FIG. 3 illustrates a high-level diagram of a computing device that may be used to implement various aspects of the present disclosure. Computing device 1100 comprises a processor 1110 operatively coupled to a data storage device 1120 and a memory 1130. Processor 1110 controls the overall operation of computing device 1100 by executing computer program instructions that define such operations. The computer program instructions may be stored in data storage device 1120, or other computer readable mediums, and loaded into memory 1130 when execution of the computer program instructions is desired. Thus, at least the method steps of FIG. 2 can be defined by the computer program instructions stored in memory 1130 and/or data storage 1120 and controlled by processor 1110 executing the computer program instructions. For example, the computer program instructions can be implemented as computer executable code programmed by one skilled in the art to perform at least the algorithms defined by the method steps of FIG. 2. Computing device 1100 also includes one or more network interfaces for communicating with other devices via a network. Computing device 1100 also includes one or more input/output devices 1150 that enable user interaction with computing device 1100 (e.g., display, keyboard, mouse, speakers, buttons, etc.).

Processor 1110 may include both general and special purpose microprocessors, and may be the sole processor or one of multiple processors of computing device 1100. Processor 1110 may comprise one or more central processing units (CPUs), for example. Processor 1110, data storage device 1120, and/or memory 1130 may include, be supplemented by, or incorporated in, one or more application-specific integrated circuits (ASICs) and/or one or more field programmable gate arrays (FPGAs).

Data storage 1120 and memory 1130 each comprise a tangible non-transitory computer readable storage medium. Data storage 1120, and memory 1130, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1150 may include peripherals, such as a printer, scanner, display screen, etc. For example, input/output devices 1150 may include a display device such as a cathode ray tube (CRT) or liquid crystal display (LCD) monitor for displaying information to the user, a keyboard, and a pointing device such as a mouse or a trackball by which the user can provide input to computing device 1100.

One skilled in the art will readily recognize that any implementation of an actual computer, computer system, or computing device may have other structures and may contain other components, and that computing device 1100 is merely a high level representation of some of the components for illustrative purposes.

All systems and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

All systems and methods described herein may also be implemented using computers operating in a client-server relationship. Typically, in such a system, the client computer is located remotely from the server computer and interaction takes place via a network. The client-server relationship may be defined and controlled by computer programs executing on their respective client and server computers.

All systems and methods described herein may be implemented using a computer program product tangibly embodied in an information carrier, e.g., in a non-transitory machine-readable storage, for execution by a programmable processor; and the method steps described herein may be implemented using one or more computer programs executable by such processor. A computer program may be a set of computer program instructions that can be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

We claim:

1. A method of streaming data contained in a file being transferred via FTP to one or more applications, the method comprising:
scanning a log file to determine whether the file is being transmitted to a FTP server from a remote computer;
incrementally receiving data contained in the file if it is determined that the file is being transmitted, wherein the data will be received until the entirety of the file is received; and
streaming the data, as the data is being received, from the FTP server to the one or more applications before the entirety of the file is received.

2. The method of claim 1, wherein streaming the data comprises using an API to stream the data to the one or more applications.

3. The method of claim 1, wherein the one or more applications are configured to receive the data stream using an API.

4. The method of claim 1, wherein the log file is updated by the FTP server.

5. The method of claim 1, wherein the one or more applications comprises a parsing application.

6. The method of claim 5, wherein the parsing application parses text data contained in the file and automatically generates news headlines based at least in part on the text data.

7. A non-transitory computer readable medium having executable code stored thereon, that when executed, causes a computing device to perform a method of streaming data contained in a file being transferred via FTP to one or more applications, the method comprising:
scanning a log file to determine whether the file is being transmitted to a FTP server from a remote computer;
incrementally receiving data contained in the file if it is determined that the file is being transmitted, wherein the data will be received until the entirety of the file is received; and
streaming the data, as the data is being received, from the FTP server to the one or more applications before the entirety of the file is received.

8. The non-transitory computer readable medium of claim 7, wherein streaming the data comprises using an API to stream the data to the one or more applications.

9. The non-transitory computer readable medium of claim 7, wherein the one or more applications are configured to receive the data stream using an API.

10. The non-transitory computer readable medium of claim 7, wherein the log file is updated by the FTP server.

11. The non-transitory computer readable medium of claim 7, wherein the one or more applications comprises a parsing application.

12. The non-transitory computer readable medium of claim 11, wherein the parsing application parses text data contained in the file and automatically generates news headlines based at least in part on the text data.

13. A system comprising:
a server computer comprising:
a processor configured for:
scanning a log file to determine whether the file is being transmitted to a FTP server from a remote computer;
incrementally receiving data contained in the file if it is determined that the file is being transmitted, wherein the data will be received until the entirety of the file is received; and
streaming the data, as the data is being received, from the FTP server to the one or more applications before the entirety of the file is received.

14. The system of claim 13, wherein streaming the data comprises using an API to stream the data to the one or more applications.

15. The system of claim 13, wherein the one or more applications are configured to receive the data stream using an API.

16. The system of claim 13, wherein the log file is updated by the FTP server.

17. The system of claim 13, wherein the one or more applications comprises a parsing application.

18. The system of claim 17, wherein the parsing application parses text data contained in the file and automatically generates news headlines based at least in part on the text data.
